(19) United States
(12) Patent Application Publication
(10) Pub. No.: US 2026/0125117 A1
(43) Pub. Date: May 7, 2026

(54) TAILGATE ASSEMBLY

(71) Applicant: NISSAN NORTH AMERICA, INC., Franklin, TN (US)

(72) Inventor: Patrick Dean GRATTAN, Wixom, MI (US)

(21) Appl. No.: 18/935,405

(22) Filed: Nov. 1, 2024

(51) Int. Cl. B62D 33/023; B60R 9/10

(52) U.S. Cl. CPC B62D 33/023; B60R 9/10

(57) ABSTRACT

The tailgate assembly includes an interior side, an exterior side and a vehicle retention structure. The interior side is configured to face a vehicle truck bed. The exterior side is an opposite facing side with respect to the interior side. The vehicle retention structure has a tether compartment provided on the interior side. The tether compartment includes an opening in the interior side and a tether fastener retained to a wall of the opening.

### BACKGROUND

### Technical Field

The present disclosure generally relates to a tailgate assembly. More specifically, the present disclosure relates to a tailgate assembly having a vehicle retention structure.

### Background Information

Vehicles such as pick-up trucks can be equipped with racks to stow or carry human-powered vehicles such as bicycles. It has been known that conventional bicycle racks are costly, heavy and time consuming to install onto a vehicle. Additionally, trucks such as pick-up trucks cannot use a hitch-mounted bicycle rack when also towing a camper or a boat.

### SUMMARY

In view of the state of the known technology, one aspect of the present disclosure is to provide a tailgate assembly comprising an interior side, an exterior side and a vehicle retention structure. The interior side is configured to face a vehicle truck bed. The exterior side is an opposite facing side with respect to the interior side. The vehicle retention structure has a tether compartment provided on the interior side. The tether compartment includes an opening in the interior side and a tether fastener retained to a wall of the opening.

### BRIEF DESCRIPTION OF THE DRAWINGS

Referring now to the attached drawings which form a part of this original disclosure:

FIG. 1 is a rear perspective view of a vehicle equipped with a tailgate assembly in accordance with an illustrated embodiment;

FIG. 2 is a perspective view of a truck bed of the vehicle equipped with the tailgate assembly of FIG. 1;

FIG. 3 is a rear perspective view similar to FIG. 1 but without the bicycles stowed on the tailgate assembly;

FIG. 4 is a cross-sectional view of a tether compartment of the tailgate assembly taken along lines 3 – 3 in FIG. 2;

FIG. 5 is a simplified cross-sectional view of the tether compartment taken along lines 3 – 3 in FIG. 2;

FIG. 6 is an exploded view of the cross-sectional view of FIG. 5;

FIG. 7 is a cross-sectional view of the tether compartment taken along lines 7 – 7 of FIG. 2;

FIG. 8 is a cross-sectional view of the tailgate assembly taken along lines 8 – 8 of FIG. 3; and

FIG. 9 is a cross-sectional view of the tailgate assembly taken along lines 9 – 9 of FIG. 3.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

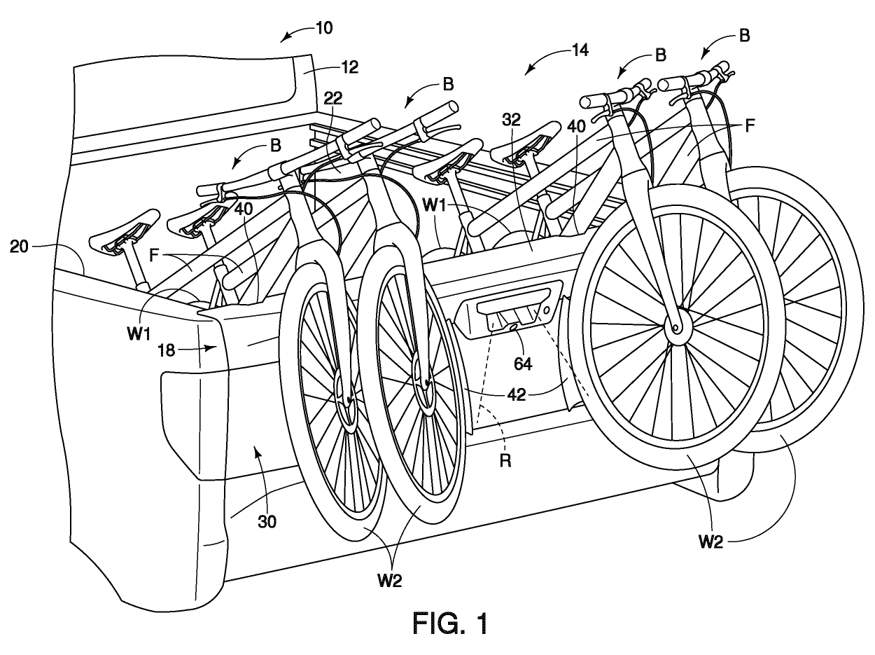

Referring initially to FIG. 1, a portion of a vehicle 10 is illustrated in accordance with an illustrated embodiment. The vehicle 10 is a pick-up truck which is a light-duty truck having an enclosed cab 12 and a truck bed assembly 14 that is configured for cargo storage. The truck bed assembly 14 includes a truck bed 16 or cargo box that defines a cargo storage space S. The truck bed assembly 14 is further equipped with the tailgate assembly 18 as will be described below.

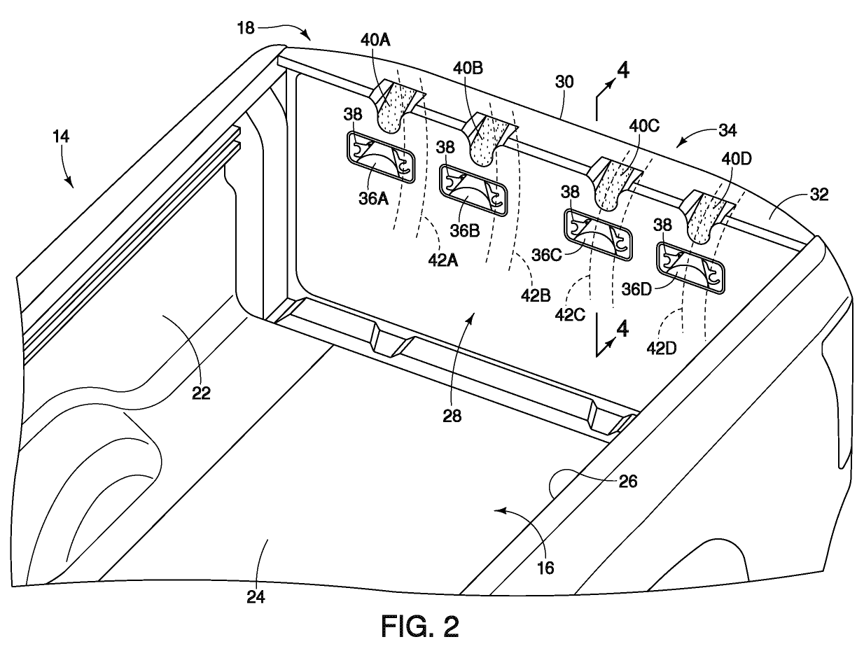

The cargo box 16 comprises a first sidewall 20, a second sidewall 22 and a truck floor 24 connecting the first and second sidewalls 20 and 22 as seen in FIG. 2. The truck bed 16 further includes a front wall 26 and the tailgate assembly 18. In particular, the tailgate assembly 18 defines a tailgate for the truck bed 16 that encloses a rear end of the truck bed 16.

Referring to FIGS. 1 and 2, the tailgate assembly 18 comprises an interior side 28 configured to face the truck bed 16 when the tailgate assembly 18 is in an upright position that encloses the truck bed 16. The tailgate assembly 18 further comprises an exterior side 30 that is an opposite facing side with respect to the interior side 28. The tailgate assembly 18 further comprises a top surface 32 extending between the interior and exterior sides 28 and 30 as best seen in FIG. 2. The tailgate assembly 18 further comprises a vehicle retention structure 34. The vehicle retention structure 34 is provided on the interior and exterior sides 28 and 30 as well as on the top surface 32.

In the illustrated embodiment, the vehicle retention structure 34 is provided to retain a human-powered vehicle, such as a bicycle B, to the tailgate assembly 18. It has been known that conventional bicycle racks are costly, heavy and time consuming to install onto a vehicle. Additionally, trucks such as pick-up trucks cannot use a hitch-mounted bicycle rack when also towing a camper or a boat.

Therefore, the tailgate assembly 18 of the illustrated embodiment is provided to enable bicycles B and other human-powered vehicles to be attached to the tailgate assembly 18. As shown, the tailgate assembly 18 is provided such that the bicycles B are stowed over the tops of the tailgate assembly 18 preferably with the rear wheels W1 stowed within the truck bed 16 and the front wheels W2 positioned exterior of the truck bed 16. The tailgate assembly 18 of the illustrated embodiment is provided to retain portions of a bicycle B such part of a bicycle frame F or part of a bicycle wheel as will be described below. In this way, the vehicle 10 equipped with the tailgate assembly 18 of the illustrated embodiment can stow at least one bicycle B while still leaving much of the cargo space in the truck bed 16 is usable for other storage. Additionally, the positioning of the bicycles B when stowed on the tailgate assembly 18 allows for easy stowage and removal of the bicycles B.

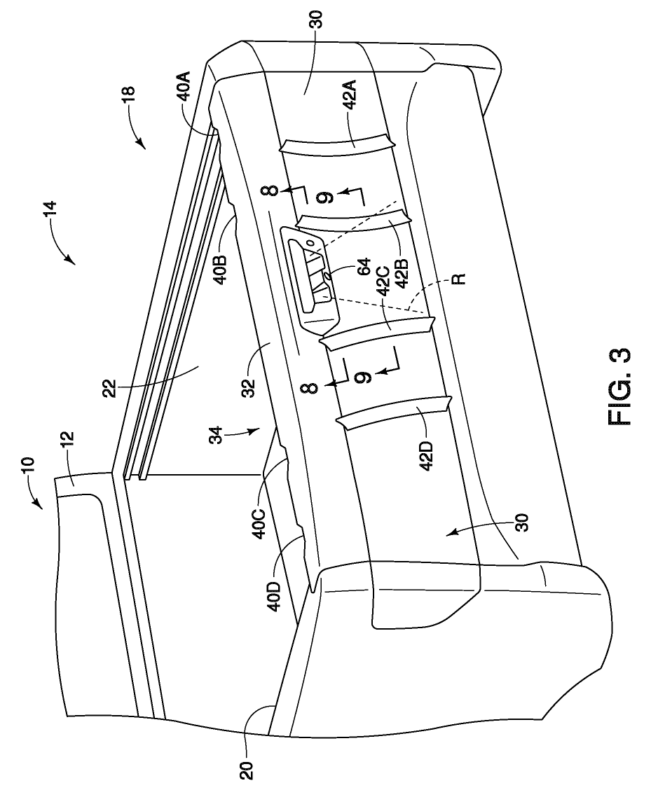

As best seen in FIG. 2, the vehicle retention structure 34 has a tether compartment 36 provided on the interior side 28 of the tailgate assembly 18. The tether compartment 36 contains a tether 38 or fastener for securing the bicycle B to the tailgate assembly 18 as best seen in FIGS. 3 to 6. The vehicle retention structure 34 of the illustrated embodiment further includes a receptacle 40 and a mounting groove 42. The receptacle 40 is provided on the top surface 32. The mounting groove 42 is provided on the exterior side 30. The receptacle 40 and the mounting groove 42 are also provided for retaining portions of the bicycle B.

In the illustrated embodiment, the tailgate assembly 18 is equipped with the vehicle retention structure 34 that includes a plurality of tether compartments, a plurality of receptacles and a plurality of mounting grooves provided along the tailgate assembly 18. As an example shown, the tailgate assembly 18 includes first, second, third and fourth tether compartments 36A, 36B, 36C and 36D. The tailgate assembly 18 includes first, second, third and fourth receptacles corresponding 40A, 40B, 40C and 40D to the first, second, third and fourth tether compartments 36A, 36B, 36C and 36D respectively. The tailgate assembly 18 further includes first, second, third and fourth mounting grooves 42A, 42B, 42C and 42D corresponding to the first, second, third and fourth tether compartments 36A, 36B, 36C and 36D and receptacles respectively 40A, 40B, 40C and 40D.

That is, the vehicle retention structure 34 shown in the illustrated embodiment is provided to retain four bicycles B to the tailgate assembly 18. However, it will be apparent to those skilled in the vehicle field from this disclosure that the tailgate assembly 18 can be equipped with a vehicle retention structure 34 having varying numbers of tether compartments 36, receptacles 40 and mounting grooves 42 to retain different numbers of bicycle(s) B as needed and/or desired.

As stated, the vehicle retention structure 34 includes the first tether compartment 36A, the first receptacle 40A and the first mounting groove 42A. For simplicity, only the first tether compartment 36A, the first receptacle 40A and the first mounting groove 42A will be described herein. As best seen in FIGS. 1 and 2, the first tether compartment 36A corresponds to the first receptacle 40A of the plurality of receptacles such that the first tether compartment 36A is positioned directly below the first receptacle 40A on the interior side 28 when the tailgate assembly 18 is in the upright position. The first mounting groove 42A corresponds to the first receptacle 40A and the first tether compartment 36A such that the first mounting groove 42A is positioned directly below the first receptacle 40A on the exterior side 30 when the tailgate assembly 18 is in the upright position.

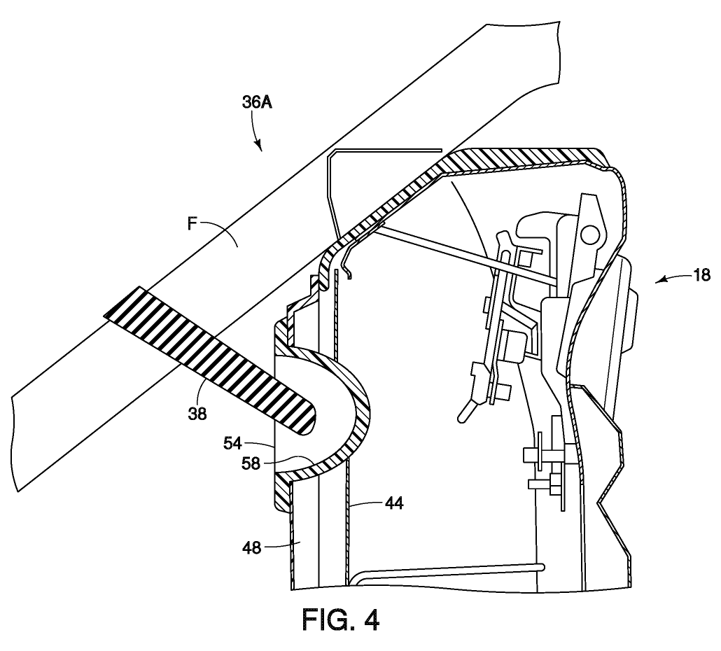

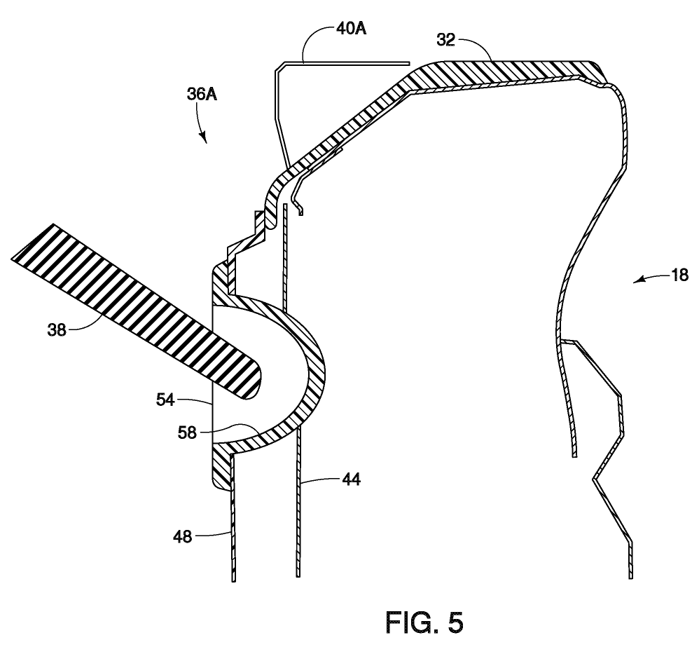

Referring to FIGS. 4 and 5, the interior side 28 includes a first metal panel 44 having a panel cutout 46 for containing the first tether compartment 36A. The interior side 28 includes a first trim panel 48 layered over the first metal panel 44, the first trim panel 48 includes a trim cutout 50 for containing the first tether compartment 36A. The first tether compartment 36A is disposed through the panel cutout 46 and the trim cutout 50. That is, the first tether compartment 36A is supported to the interior side 28 by the panel cutout 46 and the trim cutout 50.

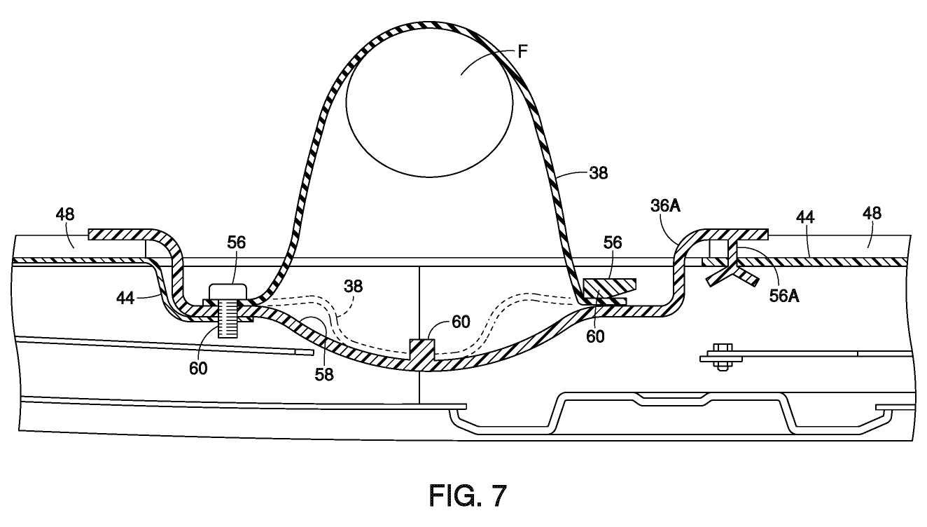

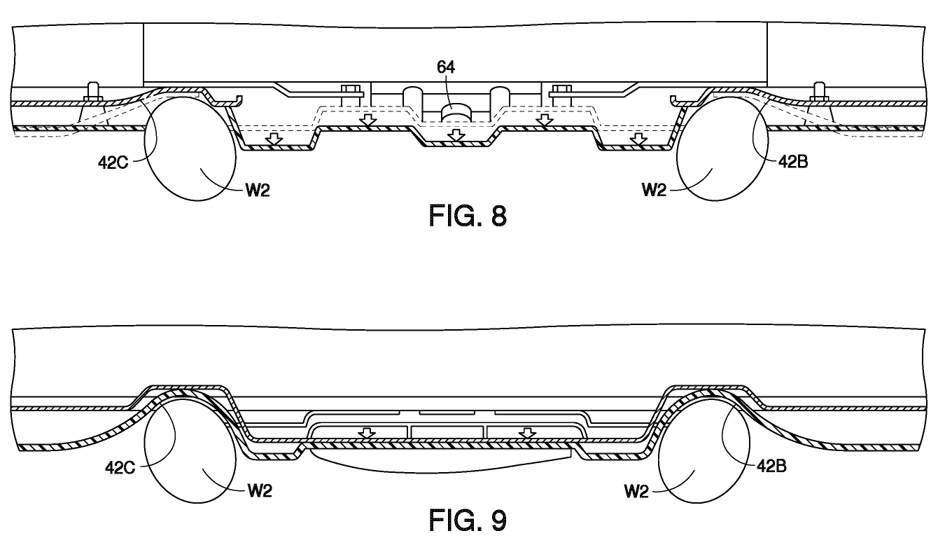

As best seen in FIGS. 7 and 8, the exterior side 30 includes a second trim panel 52. The mounting grooves 42A, 42B, 42C and 42D are disposed on the second trim panel 52. The first metal panel 44 can be made of stainless steel or aluminum that is conventional for tailgate assemblies. The first and second trim panel 48 and 52 are preferably plastic panels that are provided over respective metal panels to provide a finished appearance to the tailgate assembly 18. The first trim panel 48 preferably has a rough, textured or distressed surfaces. The second trim panel 48 has a preferably has a smooth finished surface.

Referring to FIGS. 3 to 5, the first tether compartment 36A includes an opening 54 in the interior side 28 and a tether fastener 56 retained to a wall 58 of the opening 54. The wall 58 of the first tether compartment 36A is made from injection molded plastic. The first tether compartment 36A can be considered a well provided on the interior side 28 of the tailgate assembly 18. As best seen in FIG. 3, the first tether compartment 36A is provided to secure a portion of a bicycle frame F thereto, such as a bicycle downtube.

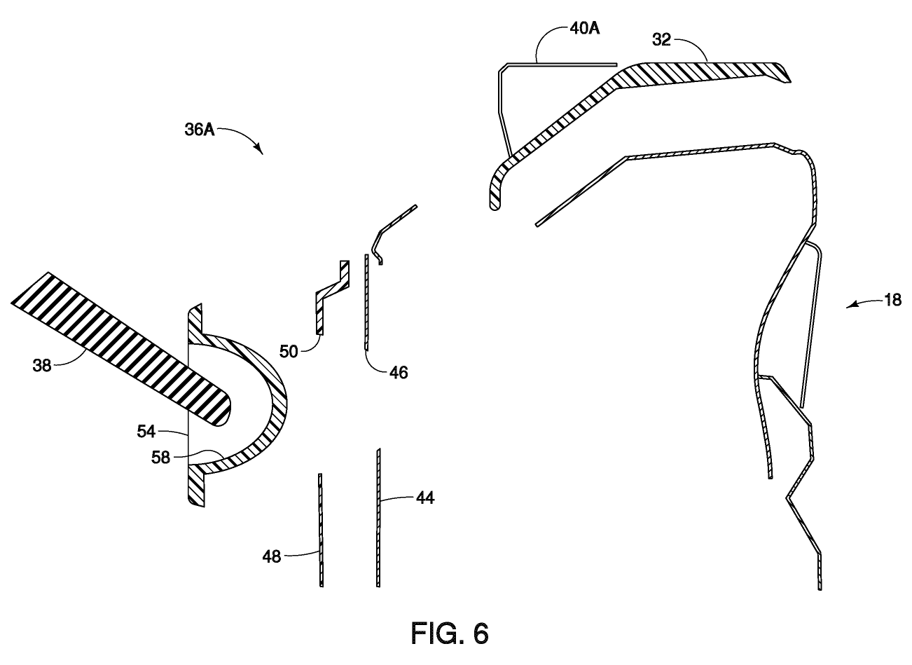

As best seen in FIG. 6, the first tether compartment 36A includes at least one retainer for retaining a tether or strap to the wall of the first tether compartment 36A. The retainer can include the tether fastener 56 or include any other types of retainers. Preferably, the first tether compartment 36A contains a pair of retainers 56 extending from the wall of the first tether compartment 36A. The retainers 56 can be a pair of fasteners, pins or bolts extending from the wall of the first tether compartment 36A.

Alternatively, the retainer 56 can include a bolt that fastens the wall of the first tether compartment 36A to the first metal panel 44 at a first side of the wall 58 as shown in FIG. 6. The retainer 56 can include a clip that is molded with respect to the wall at a second side of the wall 58 that is opposite with respect to the first side as shown in FIG. 6. The retainer 56A is a plastic clip that is molded into the first tether compartment 36A and fastens the wall of the first tether compartment 36A to the first metal panel 44.

It will be apparent to those skilled in the vehicle field from this disclosure that the fasteners of the retainer 56 can also both be molded with respect to the wall of the tether compartment. It will also be apparent those skilled in the vehicle field from this disclosure that the fasteners can be bolts that are bolted or separately attached to the wall 58 to retain the wall 58 to the first metal panel 44.

The tether is stowed in the first tether compartment 36A such that the tether is sub-flush with respect to the interior side 28 (as shown by the dashed lines in FIG. 6). The tether 38 is pulled out of the first tether compartment 36A and wrapped around a bicycle part in a retention state of the tether 38 to retain the bicycle B thereto. The tether is preferably a rubber strap that is conventionally used as bicycle straps that are made of elastic materials that can stretch to fit around the bicycle downtube. In the illustrated embodiment, an identical tether is provided to each of the first, second, third and fourth tether compartments 36A, 36B, 36C and 36D.

Referring still to FIG. 2, the vehicle retention structure 34 further has the first receptacle 40A provided on the top surface 32 at a location that is directly above the first tether compartment 36A when the tailgate assembly 18 is in the upright position to correspond to the first tether compartment 36A. The first receptacle 40A includes an inclined surface 62 that depresses towards the interior side 28. Preferably, the inclined surface 62 is provided on the top surface 32 and on the interior side 28.

In the illustrated embodiment, the first receptacle 40A is formed as a molded channel in the top surface 32. The inclined surface 62 is preferably textured or distressed to retain another portion of the bicycle frame F to prevent rattling. In particular, the first receptacle 40A includes a rubber attachment that is provided onto the inclined surface 62 to help retain the bicycle B by friction. As shown, the inclined surface inclines downward from the top surface 32 towards the interior side 28. In the illustrated embodiment, the inclined surface 62 is preferably provided to correspond to an overall shape of a bicycle downtube when installed onto the retention structure. That is, the bicycle downtube will extend downward from the top surface 32 towards the interior side 28 and into the truck bed, as illustrated in FIG. 1. Additionally, the top surface 32 can be a ridged injection molded plastic cap that includes at least a portion of the receptacle 40A formed integrally therewith.

As shown in FIGS. 1, 7 and 8, the first mounting groove 42A is provided at a location that is directly below the first receptacle 40A when the tailgate assembly 18 is in the upright position to correspond to the first receptacle 40A and the tether compartment 36A. As best seen in FIG. 1, the first mounting groove 42A is provided to receive portions of the bicycle tire or wheel, such as the front tire. The first mounting groove 42A is preferably formed as a channel or groove in the second trim panel 52 that is provided on the exterior side 30. The first mounting groove 42A also preferably includes a distressed or textured surface such as a rubber surface that can frictionally receive the tire.

As shown, the first, second, third and fourth mounting grooves 42A, 42B, 42C and 42D are provided on either side of the vehicle’s 10 rear detection system 64 such as the rear camera or sonar system that are also provided on the exterior side 30 of the tailgate assembly 18. In particular, the first, second, third and fourth mounting grooves 42A, 42B, 42C and 42D are elongated channels curving away from the detection range R of the rear detection system 64. When the bicycle wheels are disposed in the first, second, third and fourth mounting grooves 42A, 42B, 42C and 42D, the wheels W2 are retained to the tailgate assembly 18 at an angle directed away from the rear detection system 64. In this way, the bicycle wheels W1 do not obstruct the rear detection system 64 when the bicycles B are stowed on the tailgate assembly 18.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, "including", "having" and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the tailgate assembly. Accordingly, these terms, as utilized to describe the present invention should be interpreted relative to a vehicle equipped with the tailgate assembly.

The term “configured” as used herein to describe a component, section or part of a device that is constructed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A tailgate assembly comprising:
an interior side configured to face a vehicle truck bed;
an exterior side that is an opposite facing side with respect to the interior side; and
a vehicle retention structure having a tether compartment provided on the interior side, the tether compartment including an opening in the interior side and a tether fastener retained to a wall of the opening.

2. The tailgate assembly according to claim 1, wherein
the wall of the tether compartment is made from injection molded plastic.

3. The tailgate assembly according to claim 2, further comprising
a top surface extending between the interior and exterior sides, the vehicle retention structure further having a receptacle provided on the top surface at a location that is directly above the tether compartment when the tailgate assembly is in an upright position to correspond to the tether compartment.

4. The tailgate assembly according to claim 3, wherein
the receptacle includes an inclined surface that depresses towards the interior side.

5. The tailgate assembly according to claim 3, wherein
the inclined surface is provided on the top surface and on the interior side.

6. The tailgate assembly according to claim 3, wherein
the vehicle retention structure further includes a mounting groove provided on the exterior side at a location that is directly below the receptacle when the tailgate assembly is in the upright position to correspond to the receptacle and the tether compartment.

7. The tailgate assembly according to claim 4, wherein
the vehicle retention structure includes a plurality of tether compartments, a plurality of receptacles and a plurality of mounting grooves.

8. The tailgate assembly according to claim 7, wherein
a first tether compartment of the plurality of tether compartments corresponds to a first receptacle of the plurality of receptacles such that the first tether compartment is positioned directly below the first receptacle on the interior side when the tailgate assembly is in the upright position.

9. The tailgate assembly according to claim 8, wherein
a first mounting groove of the plurality of mounting grooves corresponds to the first receptacle and the first tether compartment such that the first mounting groove is positioned directly below the first receptacle on the exterior side when the tailgate assembly is in the upright position.

10. The tailgate assembly according to claim 1, wherein
the interior side includes a first metal panel having a panel cutout for containing the tether compartment.

11. The tailgate assembly according to claim 10, wherein
the interior side includes a first trim panel layered over the first metal panel, the first trim panel includes a panel cutout for containing the tether compartment.

12. The tailgate assembly according to claim 6, wherein
the exterior side includes a second trim panel, the mounting groove being disposed on the second trim panel.

13. The tailgate assembly according to claim 6, wherein
the interior side includes a first metal panel having a panel cutout for containing the tether compartment.

14. The tailgate assembly according to claim 13, wherein
the interior side includes a first trim panel layered over the first metal panel, the first trim panel includes a panel cutout for containing the tether compartment.

15. The tailgate assembly according to claim 14, wherein
the vehicle retention structure includes a plurality of tether compartments, a plurality of receptacles and a plurality of mounting grooves.

16. The tailgate assembly according to claim 15, wherein
a first tether compartment of the plurality of tether compartments corresponds to a first receptacle of the plurality of receptacles such that the first tether compartment is positioned directly below the first receptacle on the interior side when the tailgate assembly is in the upright position.

17. The tailgate assembly according to claim 16, wherein
a first mounting groove of the plurality of mounting grooves corresponds to the first receptacle and the first tether compartment such that the first mounting groove is positioned directly below the first receptacle on the exterior side when the tailgate assembly is in the upright position.
